(19) United States
(12) Patent Application Publication
(10) Pub. No.: US 2009/0038957 A1
(43) Pub. Date: Feb. 12, 2009

(54) GOLD PLATING LIQUID AND GOLD PLATING METHOD

(75) Inventors: Toshiaki Sakakihara, Fukuoka (JP); Yasuhiro Kawase, Fukuoka (JP); Fumikazu Mizutanii, Fukuoka (JP); Makoto Ishikawa, Fukuoka (JP); Yoshihide Suzuki, Osaka (JP); Keiichi Sawai, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignees: MITSUBISHI CHEMICAL CORPORATION, Minato-ku (JP); SHARP KABUSHIKI KAISHA, Osaka-shi (JP)

(21) Appl. No.: 11/718,471

(22) PCT Filed: Oct. 21, 2005
(86) PCT No.: PCT/JP05/19404

§ 371 Date: Jan. 14, 2008

(30) Foreign Application Priority Data
Nov. 2, 2004 (JP) 2004-319451

(51) Int. Cl. C25C 1/20; C09D 7/00

(52) U.S. Cl. 205/571

(57) ABSTRACT

In a stable gold plating liquid having a low toxicity besides properties comparable to those of a cyan-type gold plating liquid, iodine and/or iodide ions, gold ions, and a polyalcohol having at least 4 carbon atoms are contained. The polyalcohol having at least 4 carbon atoms may be diethylene glycol or triethylene glycol. The content of the polyalcohol having at least 4 carbon atoms in the gold plating liquid is generally 10 to 90 percent by weight. The gold plating liquid may contain water.

### TECHNICAL FIELD

The present invention relates to a gold plating liquid and a gold plating method, and more particularly, relates to a non-cyan-type electrolytic gold plating liquid and an electrolytic gold plating method using this gold plating liquid.

### BACKGROUND ART

As a gold plating liquid, a cyan-type plating liquid has been known from old times. When a cyan-type gold plating liquid is used, a dense gold plating film having superior surface smoothness properties can be precipitated. Since being stable and easily controlled, a cyan-type gold plating liquid has been widely used. However, cyanogen has strong toxicity, and hence there have been many problems relating to working environment, waste liquid treatment, and the like.

As a non-cyan-type and low-toxicity gold plating liquids as described in Patent 1 listed below, a gold plating liquid in which gold sulfite is dissolved has been widely used. However, in this gold plating liquid, the sulfite ions in the solution are liable to be oxidized by dissolved oxygen and/or oxygen in the atmosphere, and hence the life as a gold plating liquid is liable to be degraded. Accordingly, it is necessary to provide oxidation preventing means by using a nitrogen seal or the like even during storage and plating operation, and hence the handling is not easily performed.

In Patent 2 listed below, a gold plating liquid is described in which a thiosulfate gold complex, a sulfite salt, boric acid, and ethylene glycol are dissolved. However, also in this gold plating liquid, the sulfite ions in the plating liquid are liable to be oxidized.

In Patents 3 and 4 listed below, for example, there are described a gold plating liquid in which a gold compound selected from the group consisting of various gold complexes, such as an acetylcysteine gold complex, and acetylcysteine as a complexing agent are dissolved; and a gold plating liquid which contains at least one type of alkane sulfonic acids and alkanol sulfonic acids, gold ions, and a nonionic surfactant. In both the plating liquids, since monovalent gold ions are contained as is the case of the gold plating liquid containing gold sulfite, precipitation of gold by reaction of 3Au⁺→2Au+Au³⁺ is liable to occur, and hence the gold plating liquids are unstable.

In Patents 5 to 8 listed below, gold plating liquids are described in which an ethylenediamine gold complex, which contains trivalent gold ions, is dissolved. However, ethylenediamine is toxic (Chemical Substance Toxicity Handbook, vol. II, II-84, (1999) published by Maruzen).

When electrolytic gold plating is performed by using a gold solution in which gold is dissolved in a solution containing iodine (I₂) and iodide ions (I⁻), by gold plating performed under the presence of an organic solvent, a black gold plating film is obtained (Fourteenth year of Heisel National Science Education General Assembly, vol. 24, p. 66-67). However, since gold crystalline grains of the gold plating film thus formed are coarse, the gold plating film is in black color, and hence a glossy and beautiful gold plating film cannot be obtained.

In Patent 9 listed below, a gold plating liquid is described in which iodine and/or iodide ions, gold ions, and ethylene glycol used as a non-aqueous solvent are contained. However, in order to dissolve a metal complex, a large amount of ethylene glycol must be used. Since ethylene glycol falls under the category of the substance whose use is regulated by the “law relating to keep track release amount of particular chemical substance to environment and promoting improvement of management” hereinafter referred to as the “PRTR law”), the reduction in use amount of ethylene glycol and the use of alternative solvent instead thereof have been desired.

As described above, the conventional gold plating liquids have the following shortcomings:

1) problems relating to working environment and waste liquid treatment caused by toxic substances;

2) low chemical stability due to easily oxidizable property or the like; and

3) coarsening of gold crystalline grains of gold plating film.

In particular, when the gold crystalline grains of the gold plating film are coarse, the degree of gloss and the smoothness of the gold plating film are degraded and as a result, it becomes difficult to use the gold plating film for applications of ornamentation and electronic components. Accordingly, a gold plating liquid has been pursued which is safe, chemically stable, and superior in handling properties, and, at the same time, which can form a dense and smooth gold plating film having fine gold crystalline grains.

### Patent Document 1: Japanese Unexamined Patent Application Publication No. 11-61480

### Patent Document 2: Japanese Unexamined Patent Application Publication No 51-47539

### Patent Document 3: Japanese Unexamined Patent Application Publication No. 10-317183

### Patent Document 4: Japanese Unexamined Patent Application Publication No. 8-41676

### Patent Document 5: Japanese Unexamined Patent Application Publication No 11-293487

### Patent Document 6: Japanese Unexamined Patent Application Publication No. 2000-204496

### Patent Document 7: Japanese Unexamined Patent Application Publication No 2000-355792

### Patent Document 8: Japanese Unexamined Patent Application Publication No. 2001-110832

### Patent Document 9: Japanese Unexamined Patent Application Publication No. 2004-43958

Non-Patent Document 1: Chemical Substance Toxicity Handbook, vol. II, II-84, (1999) published by Maruzen
Non-Patent Document 2: Fourteenth years of Heisei National Science Education General Assembly, vol. 24, p. 66-67

### SUMMARY OF THE INVENTION

A gold plating liquid according to the present invention contains iodine and/or iodide ions, gold ions, and a polyalcohol having at least 4 carbon atoms.

A gold plating method according to the present invention is performed by using this gold plating liquid.

### BEST MODE FOR CARRYING OUT THE INVENTION

In a gold plating liquid containing iodine and/or iodide ions, gold ions, and ethylene glycol when a polyalcohol having at least 4 carbon atoms is used Instead of ethylene glycol, or in particular, when diethylene glycol or triethylene glycol is preferably used, it was found that a gold plating liquid can be easily prepared, and that the amount of a non-aqueous solvent in the gold plating liquid can be decreased. The above polyalcohols do not fall under the PRTR law.

The reason the preparation of a gold plating liquid becomes easier when a polyalcohol having at least 4 carbon atoms is contained therein has not been clearly understood; however, it is estimated that as for the ability of stabilizing a gold complex, a polyalcohol having at least 4 carbon atoms is superior to ethylene glycol. As described above, since a non-aqueous solvent superior in stabilizing a gold complex is used, in the present invention, a gold plating liquid can be prepared with a smaller amount of a non-aqueous solvent.

Since the gold plating liquid of the present invention contains both iodine and iodide ions, it has a high gold-dissolving power. In the gold plating liquid according to the present invention, a gold complex in a polyalcohol solution containing iodine and/or iodide ions is very stable, and hence even when it is brought into contact with dissolved oxygen and/or oxygen in the atmosphere, the gold complex can be stably present in the form of a gold liquid. Accordingly even during storage and plating operation, it is not necessary to provide oxidation preventing means by using a nitrogen seal or the like, and hence the handling properties are also superior.

According to the present invention, besides having properties comparable to those of a cyan-type gold plating liquid, a gold plating liquid which is safe and stable can be provided. By the gold plating liquid of the present invention, which has a high liquid stability and is safe since the toxicity is reduced, a gold plating film can be simply and easily formed.

In a gold plating method according to the present invention, when electrolytic plating is performed by using gold or a gold alloy as an anode material, gold of the anode is dissolved in a plating liquid, and the amount of gold corresponding to that in the gold plating liquid, which is decreased by plating, can be supplied thereto; hence, stable plating can be performed for a long period of time.

In addition, by the present invention, plating of a gold alloy can also be easily performed in accordance with a purpose or application.

The gold plating liquid according to the present invention does not contain cyanogen or the like having a strong toxicity, which causes problems relating to working environment and waste liquid treatment, is superior in chemical stability does not require oxidation preventing means and the like, and can be stably and easily handled even in the atmosphere Gold crystalline grains of a gold plating film formed from this gold plating liquid is dense and fine and is superior in surface smoothness. This gold plating film is preferably used for ornaments which require high surface smoothness and gloss and for electronic components such as a connector terminal and a printed circuit board.

Hereinafter, preferable embodiments of the gold plating liquid and the gold plating method according to the present invention will be described in more detail.

The gold plating liquid of the present invention contains iodine and/or iodide ions, gold ions, and a polyalcohol having at least 4 carbon atoms and substantially does not contain cyanogen. The iodide ions and the gold ions may be independently contained or may be contained in the form of AuI₂⁻ or AuI₄⁻; however, in the common case, gold ions in the form of complex ions are contained in a gold plating liquid.

The content of gold ions of the gold plating liquid according to the present invention is with respect to the total gold plating liquid, generally 0.01 percent by weight or more, preferably 0.1 percent by weight or more, more preferably 0.5 percent by weight or more, or particularly preferably 1 percent by weight or more, and generally 50 percent by weight or less, preferably 30 percent by weight or less, more preferably 10 percent by weight or less, or particularly preferably 5 percent by weight or less. When the content of gold ions is less than the lower limit described above, the time necessary for the plating is increased, and when the content is more than that described above, it is difficult to dissolve gold.

Although containing iodine (I₂) and/or iodide ions (I⁻), the gold plating liquid of the present invention preferably contains both iodine and iodide ions.

The content of iodine (I₂) and/or iodine ions (I⁻), the total of which is represented on an iodine form basis, of the gold plating liquid according to the present invention is, with respect to the total gold plating liquid, generally 0.1 percent by weight or more, preferably 0.5 percent by weight or more, more preferably 1 percent by weight or more, or particularly preferably 5 percent by weight or more, and generally 75 percent by weight or less, preferably 50 percent by weight or less, more preferably 30 percent by weight or less, or particularly preferably 20 percent by weight or less. When the iodine content is less than the lower limit described above, it is difficult to stably dissolve gold, and when the content is more than that described above, an electrode may be damaged in some cases. Although this iodine content can be obtained by measurement, it can also be obtained from the amounts of raw materials which are supplied when the gold plating liquid of the present invention is prepared.

The weight ratio of iodine to iodide ions in the gold plating liquid is preferably set on a weight ratio basis determined in preparation therefor so that iodine (I₂)/iodine ions (I⁻) is ⅓ to 1/1,000, is preferably ¼ to 1/100, and is more preferably ⅕ to 1/10. In the case in which the content of iodine (I₂) in the gold plating liquid is excessive, for example, when gold films (or gold alloy films) laminated to each other are used as a cathode for gold plating, the electrode is considerably dissolved by iodine (I₂) in the gold plating liquid, and as a results desired plating may not be performed in some cases. Hence, the content of iodine (I₂) in the gold plating liquid of the present invention is preferably decreased as long as it may not damage the performance as the gold plating liquid.

In general, it is extremely difficult to dissolve iodine (I₂) in a polar solvent; however, when iodide ions (I⁻) are present in a solution, by reaction of

I₂+I⁻→I₃⁻,

triiodide ions (I₃⁻) are formed and are likely to be dissolved. The triiodide ions (I₃⁻) thus formed react with gold as shown by the following equation and are then dissolved in the form of a gold iodide complex, and hence, as a result, it has been believed that dissolution of gold is facilitated.

I₃⁻+I⁻+2Au→2(AuI₂)⁻

Since triiodide ions (I₃⁻) serve to improve solution stability of the gold iodide complex and also work to prevent gold to be precipitated by decomposition of the gold iodide complex it is preferably present in the solution to a certain extent. The triiodide ions (I₃⁻) are preferably present in the gold plating liquid at a concentration of 0.001 percent by weight or more, more preferably 0.005 percent by weight or more, and further preferably 0.01 percent by weight or more.

Triiodide ions (I₃⁻) receive electrons at the cathode as shown below,

I₃⁻+2e⁻→3I⁻

and as a result, reaction also occurs in which iodide ions (I⁻) are generated. Since this is a competitive reaction when gold is precipitated by reduction at the cathode, when the amount of triiodide ions (I₃⁻) is excessive a current efficiency for gold precipitation is degraded. Accordingly, triiodide ions (I₃⁻) are preferably present in the gold plating liquid at a concentration of 0.6 percent by weight or less more preferably 0.4 percent by weight or less, and further preferably 0.2 percent by weight or less.

Since triiodide ions (I₃⁻) absorb light at a wavelength of 360 nm in a ultraviolet region, when the absorption intensity at this wavelength is measured and analyzed the quantification can be performed.

In preparing the gold plating liquid of the present invention, when an iodide salt is used as an iodide ion source, in the gold plating liquid of the present inventions cations derived from the iodide salt used as a raw material are to be contained. The cations are preferably alkali metal ions, ammonium ions, primary, secondary, tertiary, or quaternary alkylammonium ions, phosphonium ions, sulfonium ions, and the like; are more preferably alkali metal ions such as sodium ions and potassium ions; and particularly preferably potassium ions In the gold plating liquid of the present invention, only one type of cations mentioned above may be contained, or at least two types thereof may also be contained.

The gold plating liquid of the present invention contains a non-aqueous solvent which is a polyalcohol having at least 4 carbon atoms.

The polyalcohol having at least 4 carbon atoms is preferably a divalent or a trivalent polyalcohol having 4 to 6 carbon atoms, such as diethylene glycol or triethylene glycol, and is particularly preferably diethylene glycol. Since the compounds mentioned above are superior in dissolving a gold complex, the use amount of a non-aqueous solvent can be decreased. In addition, the above compounds do not fall under the PRTR law and are advantageous since they are also desirable for environment. These polyalcohols may be used alone, or at least two types thereof may be used in combination.

The content of the polyalcohol having at least 4 carbon atoms in the gold plating liquid according to the present invention is, with respect to the total of the gold plating liquid, generally 10 percent by weight or more, preferably 20 percent by weight or more, or more preferably 30 percent by weight or more, and generally 90 percent by weight or less, preferably 85 percent by weight or less, more preferably 80 percent by weight or less, or particularly preferably 75 percent by weight or less.

When the gold plating liquid of the present invention contains water, the content thereof is, with respect to the total of the gold plating liquid, generally 1 percent by weight or more, preferably 5 percent by weight or more, or more preferably 10 percent by weight or more, and generally 90 percent by weight or less, preferably 85 percent by weight or less, or more preferably 75 percent by weight or less. In addition, the ratio of water to the polyalcohol having at least 4 carbon atoms is preferably 1 percent by weight or more, more preferably 5 percent by weight or more, even more preferably 10 percent by weight or more, or particularly preferably 20 percent by weight or more, and generally 90 percent by weight or less, or preferably 80 percent by weight or less.

The gold plating liquid of the present invention may contain a non-aqueous solvent other than the above polyalcohol having at least 4 carbon atoms. In order not to degrade a superior effect of stabilizing a gold complex by the above polyalcohol used in the present inventions the content of the non-aqueous solvent in the gold plating liquid is 50 percent by weight or less, or in particular 20 percent by weight or less, and the content with respect to the above polyalcohol is 100 percent by weight or less, or in particular 25 percent by weight or less.

The gold plating liquid of the present invention contains iodine and/or iodide ions, gold ions, and a polyalcohol having at least 4 carbon atoms, and may further contain water.

The gold plating liquid may further contain an additive capable of improving properties of a plating film. The additive may be at least one material selected from additives, which have been used in a known cyan-type or sulfite-type plating solution, and materials other than those described above. The addition amount of the additive is not particularly limited, and an appropriate amount may be determined in consideration of the effect and the cost.

As the additive, when a water soluble polymer is added, the crystalline structure of gold can be made dense. In this embodiment, the “polymer” is a “broad-sense polymer” that includes an “oligomer”.

In consideration of the solubility in the gold plating liquid, storage stability, and the like, the water soluble polymer preferably has at least one group selected from the following substituents and linking groups (D1) to (D3) in a main chain having a repeating unit structure or in a side chain.

(D1): at least one acidic substituent selected from the group consisting of —CO₂H—, —SO₃H, and —PO₃H₂.
(D2): at least one basic substituent or a linking group selected from the group consisting of —CONR—, —CH₂—NR—CH₂—, NR₂, and —NR₃⁺ (where R indicates a hydrogen atom, an alkyl group having 1 to 4 carbon atoms, a methylene group, or a halogen group. When at least two R's are present in one substituent, the R's may be the same or may be different from each other).
(D3): —OH of a non-electrolytic substituent

As a water soluble polymer having the above substituent or linking group (D1) to (D3), for example, poly(vinyl alcohol), polyacrylamide, poly(acrylic acid), poly(vinyl pyrrolidone), water soluble alkyd, poly(vinyl ether), poly(maleic acid) copolymer, or polyethyleneimine may be mentioned as a synthetic organic compound. As a semi-synthetic compound, for example, there may be mentioned soluble starch, carboxyl-starch, British gum, dialdehyde starch, dextrin, cyclodextrin, cationic starch, viscose, methylcellulose, ethylcellulose, carboxymethylcellulose, or hydroxyethylcellulose. In addition, as a natural organic compound, for example, there may be mentioned starch, poly-D-glucose, gloiopeltis glue, agar, alginate, Arabic gum, tragacanth gum, hibiscus manihot, konnyaku, glue, casein, gelatin, egg white, plasma protein, pullulan, or dextran.

These water soluble polymers may be used alone, or at least two types thereof may be used in combination.

Among these water soluble polymers, a more preferable polymer is a polymer having, as a water soluble group, an alcoholic hydroxyl group and/or —CONR— (where R represents a hydrogen atom, an alkyl group having 1 to 4 carbon atoms, a methylene group, or a halogen group). For example, as preferable polymers, there may be mentioned polyvinyl alcohol, starch, soluble starch, carboxyl starch, dextrin, cyclodextrin; polyacrylamide, poly(vinyl pyrrolidone), and as a particularly preferable polymer, poly(vinyl pyrrolidone) itself or a mixture thereof with one of the above water soluble polymers may be mentioned.

The weight average molecular weight of the water soluble polymer is preferably 500 to 3,000,000, more preferably 1,000 to 2,000,000, and most preferably 5,000 to 1,500,000.

The content of the water soluble polymer in the gold plating liquid is preferably 0.0001 percent by weight or more, more preferably 0.0005 percent by weight or mores or most preferably 0.001 percent by weight or more, and is preferably 5 percent by weight or less, more preferably 1 percent by weight or less, or most preferably 0.5 percent by weight or less.

When a leveling agent, a brightening agent, a crystal regulator, and the like are added to the gold plating liquid of the present invention, the crystal growth and the orientation of gold ions can be controlled during reduction precipitation on the cathode, the size of crystals at plating film grain boundaries can be decreased, and the smoothness of a plating film surface and the gloss of a plating film can be improved.

The gold plating liquid may include a completing agent to improve the stability of a plating bath and/or a dissolution accelerator to accelerate electrolytic dissolution when gold or a gold alloy is used for an anode as a dissolved electrode. In addition, various surfactants may also be contained so that a plating object to be plated is easily wetted.

The gold plating liquid may contain a buffering agent to perform pH adjustment for improving the stability of a plating bath and the efficiency of reduction precipitation; various types of inorganic and/or organic conductive salts in order to improve the conductivity; and various reducing agents as a controller to control a reduction precipitation rate of gold ions. As for the above additives, the addition amount is not particularly limited, and in consideration of the effect and the cost, an appropriate amount may be added.

As the leveling agent, brightening agent, and crystal regulator, various inorganic and/or organic additives are used. The inorganic additives preferably contain a transition metal element or an element of Groups 3B to 6B of the Periodic Table and more preferably contain an element from the fourth period to the sixth period. Of the elements mentioned above, an inorganic additive containing an element such as arsenic, thallium, selenium, lead, cadmium, tellurium, bismuth, antimony, tungsten, or cerium is most preferably used.

The organic additives are preferably an organic compound containing at least one element of oxygen, nitrogen, and sulfur. This organic compound preferably contains as a functional group ethylene oxide, ester, Ketone, ether, alcohol, ethyleneamine, ethyleneimine, thiol, disulfide, or the like. In particular, this organic compound is preferably at least one of poly(ethylene oxide), a compound having a polyamine or a polyethyleneimine structure, and a compound having a functional group, such as thiol, disulfide, or amine. This organic compound may also be polyethylene glycol; polyethyleneimine; an alklythiol, such as ethanethiol, 2-hydroxyethanethiol, propanethiol, or thioglycerol; or a disulfide, such as dimethyl sulfide, 4,4′-dithiobutyric acid, or bis-3-sulfopropyl disulfide-2-sodium salt. This organic compound may also have another functional group as long as it does not interfere with the function of this object. Of the additives described above, an optional one of the inorganic additives and the organic additives may be used alone, or at least two types thereof may be used in combination. The gold plating liquid may also contain halogen ions as an accessory agent for the leveling agent, brightening agent, and crystal regulator.

The completing agent used to improve the stability of a plating bath preferably has a primary coordinating group forming a metal chelater and various amines, oximes, imines, thioethers, ketones, thioketones, alkoxides, thiolatos, carboxylic acids, phosphonic acids, and sulfonic acids may be used. The completing agents may be used alone, or at least two types thereof, which are different from each other, may be appropriately used in combination. Among those mentioned above, an agent having a coordinating group, such as a carboxylic acids ketone, amine, or imine, is more preferable. As a compound having the coordinating group mentioned above, for example, tartaric acid, citric acid, acetylacetone, ethylenediamine, nitrilotriacetate, ethylenediaminetetraacetic acid, 2,2′-bipyridine, or 1,10-phenanthroline is preferable.

In the case in which gold or a gold alloy is used for an anode, the dissolution accelerator is not particularly limited as long as it is suitable to accelerate electrolytic dissolution of an anode; however, a compound having an oxidizing effect is preferable. As this oxidizing agent, a halogen, halogen acid, or perhalogen acid is more preferable, and iodine, iodic acid, periodic acid, or a salt thereof is preferable.

As the surfactant used to improve the wettability of a plating object and penetration properties into small gasps thereof, anion, cation, amphoteric, and nonion type surfactants are mentioned; however, among those mentioned above, anion, amphoteric, and nonion type surfactants are preferable, and in particular, anion and nonion type surfactants are preferable. These surfactants may be used alone, or at least two types thereof, which are different from each other, may be appropriately used in combination. As the anion type surfactant, for example, a carboxylic acid type, a sulfonic acid type, a sulfate ester type, or a phosphate ester type is preferable; as the amphoteric type surfactant, for example, an amino acid type or a betaine type is preferable; and as the nonion type surfactant, for example, a polyethylene glycol type, a polyalcohol type, an acetylene alcohol type, or an alkanolamine type is preferable.

As the anion type surfactant, a sulfonic acid type (having a —SO₃— group), a sulfate ester type (having a —OSO₃— group), or a carboxylic acid type (having a —CO₂— group), that is, a compound having at least one of a —SO₃— group, a —OSO₃— group, and —CO₂— group, is preferable, and these surfactants may be used alone, or at least two types thereof may be appropriately used in combination. In particular, an alkyl sulfonic acid, alkylbenzene sulfonic acid, alkylbenzene sulfate ester, alkyl ether sulfate ester, alkyl carboxylic acid, and a salt thereof are preferable.

As the nonionic surfactant, for example, there may be a polyoxyethylene alkyl ether, polyoxyethylene alkylphenyl ether, polyoxyethylene fatty acid ester, or polyoxyethylene sorbitan fatty acid ester as a polyoxyethylene glycol type; a polyoxyethylene polyoxypropylene ether, or polyoxyethylene polyoxypropylene alkyl ether as a polyoxyethylene glycol type; a glycerin fatty acid ester or sorbitan fatty acid ester as a polyalcohol type: an alkyne-ol or alkyne-diol as an acetylene alcohol type; or an alkylcarboxylic acid monoethanolamide or alkylcarboxylic acid diethanolamide as an alkanolamide type. Among the surfactants mentioned above, since being superior in solubility into a plating liquid and in chemical stability, for example, an alkyne-(di)ol or an alkylcarboxylic acid diethanolamide is preferable.

The buffering agent and/or the conductive salt for a plating bath is not particularly limited as long as it exhibits ionic dissociation; however, boric acid, carboxylic acid, carbonic acid, sulfurous acid, sulfuric acid, hypophosphorous acid, phosphoric acid, diphosphoric acid, halogen acid, hydroxide of alkali metal or alkaline earth metal, ammonium water, various amines, diamines, or quarterly ammonium salt is preferable. In addition, an alkali metal salt, alkaline earth metal salt, ammonium salt thereof, or the like is also preferable. The above buffering agents and/or conductive salts may be used alone, or at least two types thereof, which are different from each other, may be appropriately used in combination. Of the above buffering agents and/or conductive salts, a carboxylate, sulfate, phosphate, and diphosphate are more preferable. Of those mentioned above, in view of the stability and solubility into a plating bath, for example, a potassium, sodium, or ammonium salt of tartaric acid, citric acid maleic acid, lactic acid, fumaric acid, or succinic acid, or a potassium, sodium, or ammonium salt of hydrogen iodide, sulfuric acid, phosphoric acid, or diphosphoric acid is also preferable.

The precipitation rate controller of gold ions is not particularly limited as long as it does not interfere with the desired effect of the present invention; however, compounds having a reducing ability are preferable. Among the compounds, for example, hypophosphite, boron hydride salt, dialkylaminoborane, hydrazine, alkyldiamine, aldehydes, ureas, and thiols are more preferable. Among these precipitation rate controllers, thiourea exhibiting an oxidation-reduction potential that is not dependent on pH of a plating bath is particularly preferable. However, when particular consideration must be taken for environments it is preferable to use a substance that does not fall under the PRTR law.

In the present invention, by dissolving at least one metal other than gold in a gold plating liquid, a gold alloy plating may be performed. As the metal other than gold, for example, copper, silver, or tin, which is well known as a gold alloy, may be mentioned (by Kotoda, “Journal of Surface Finishing Society of Japan”, 47(2), 142 (1996)); another metal may also be used as long as it is dissolved in the gold plating liquid of the present invention. Anions other than iodide ions may also be added in order to dissolve a metal other than gold as long as the anions do not interfere with the desired effect of the present invention.

The gold plating liquid of the present invention substantially does not contain cyanogen. Hence, the gold plating liquid of the present invention is a superior gold plating liquid; that is, the safety is excellent, a waste liquid treatment can be easily performed, and environmental load is small. In this embodiment, “substantially does not contain cyanogen” means that cyanogen is not positively contained for the purpose of gold plating, and it is preferable that cyanogen be not contained at all. For example, when the gold plating liquid of the present invention is prepared, and even when cyanogen is contained as an impurity, of course, the content of cyanogen is preferably low, and it is preferable that the content be particularly 1 percent by weight or less, more particularly 0.1 percent by weight or less, and even more particularly 0.01 percent by weight or less.

A method for preparing the gold plating liquid of the present invention is not particularly limited, and the gold plating liquid can be obtained by mixing a gold source, an iodine source, and a non-aqueous solvent containing the polyalcohol having at least 4 carbon atoms described above together with, whenever necessary, water and other additives. For example, the preparation method described in Japanese Unexamined Patent Application Publication No 2004-43958 may be used. Preferably, a method is used in which gold or a gold alloy is dissolved in a solution containing iodine, iodide ions, and a non-aqueous solution together with, whenever necessary, water and other additives.

As the gold source of the gold plating liquid, for example, a gold alloy or elemental gold may be mentioned; however, in order to prevent intrusion of impurities, for example, elemental gold or gold iodide is preferable and in consideration of availability, elemental gold is particularly preferable. Elemental gold may have any form, such as a block, foil, plate, grains, or powder, in accordance with a method for manufacturing a gold plating liquid. By the same reason as that elemental gold is preferably used as a gold source, when a gold alloy plating liquid is prepared, in consideration of influence on a plating liquid composition, elemental metals having a composition similar to that of an ally to be obtained as a plating film are preferably used. In this case, in consideration of dissolution rates, the alloy composition may be slightly deviated from the plating film composition.

The gold plating method of the present invention can be performed by an electrolytic plating method using the gold plating liquid of the present invention. In general, constant current plating is performed; however, either constant voltage plating or a pulse plating method such as a PR method may be performed. The current density in the case of constant current plating is generally 1 to 1,000 mA/cm², preferably 2 to 300 mA/cm², more preferably 3 to 50 mA/cm², and particularly preferably 4 to 20 mA/cm².

In an electrolytic plating method using the gold plating liquid of the present invention, when plating is performed by using gold or a gold alloy, which forms a plating film, as a material for a counter electrode (anode), which is an electrode opposite to an electrode (cathode) at which plating of gold is performed by precipitation, gold or a gold alloy component can be supplied from the anode while plating is performed at the cathode, and hence stable operation can be performed in which the gold concentration and the alloy component concentration in the gold plating liquid are always maintained constant. The reason for this is that iodine and iodide ions by-produced by the gold plating reaction at the cathode oxidize and dissolve the gold of the anode. As described above, by using gold or a gold alloy for the counter electrode, plating can be performed for a long period of time, and the life of the plating liquid can be increased. When gold or a gold alloy is used for the counter electrode, in consideration of decomposition and the like of the gold plating liquid, it is preferable that the composition and the shape be optionally adjusted.

As a material for the anode, when an insoluble material such as platinum or carbon is used instead of gold, iodine and iodide ions by-produced by the gold plating reaction at the cathode again produce triiodide ions (I₃⁻) When these ions are excessively accumulated in the gold plating liquid, by the competitive reactions the current efficiency of gold plating is decreased as described above. In this case, the concentration of triiodide ions is preferably adjusted by addition of an additive reactable with triiodide ions so as to change triiodide ions into a compound which does not interfere with the gold plating reaction. The preferable concentration range of triiodide ions is as described above.

As the additive in this case, a compound reactable with triiodide ions or a substance capable of adsorbing and removing triiodide ions may be mentioned.

In the case of the compound reactive with triiodide ions, a compound can be used without any particular limitation as long as it is dissolved in the cold plating liquid, and does not interfere with the effects of the present invention. For example, there may be mentioned an aromatic compound with which triiodide ions cause an electrophilic substitution reaction a compound having a double bond with which triiodide ions cause an addition reaction, an organic compound with which triiodide ions cause a haloform reactions and a reducing agent causing reaction with triiodide ions which are a strong oxidizing agent.

The aromatic compound with which triiodide ions cause an electrophilic substitution reaction is not particularly limited; however, since an aromatic compound having no substituents has high oil solubility and is not likely to be dissolved in a gold plating liquid containing a polar solvent or water, a compound having a hydrophilic substituent, such as a hydroxyl, a carboxyl, or an amino group, is preferable. However, a strong electron-attracting group, such as a carboxyl group, attracts n electrons in an aromatic ring, and as a result, the reaction rate of electrophilic substitution reaction with iodine tends to decrease. Hence, an aromatic compound having a hydroxyl group is particularly preferable, and for example, a phenolic compound may be mentioned.

The reaction between triiodide ions and an aromatic compound is a nucleophilic substitution reaction between triiodide ions and hydrogen atoms of the aromatic compound, and in general, ortho- and para-orientations are obtained. Hence, in order to easily cause a substitution reaction, it is preferable that substituents be not provided at the ortho- and the para-positions of the above hydrophilic substitute. Above all, a phenolic compound having no substituents at the ortho- and the para-positions is preferable.

When the hydrophilic substituent has an electron-donating group at a meta-position, the π electron density of an aromatic ring is increased, and the nucleophilic substitution reaction with iodine is more likely to occur; hence, it is preferable. Accordingly, a m-alkyl substituted phenol is most preferable. Of course, it is preferable that substituents be not provided at the ortho- and the para-positions.

As the m-alkyl substituted phenol, for example, 3,5-xylenol (3,5-dimethylphenol), 3-methoxyphenol, 3-ethoxyphenol, 3-t-butylphenol, 3-n-butylphenol, 3,5-di-t-butylphenol, or 3,5-di-n-butylphenol is preferable; however, it is not limited thereto.

As the compound having a double bond with which triiodide ions cause an addition reaction, a vinyl compound having a vinyl group, an acryl group, a methacrylic group, or the like is preferable since having a high reactivity, and in particular, vinyl acetate, ethyl vinyl ether, acrylonitrile, methyl methacrylate, styrene, chlorostyrene, methylstyrene, methoxystyrene, nitrostyrene, or the like is preferable.

The organic compound with which triiodide ions cause a haloform reaction is a compound having a —COCH₃ or —CH(OH)CH₃ structure, and for example, acetone, methyl ethyl ketone, or isopropyl alcohol is preferable.

The reducing agents causing reaction with triiodide ions, which are a strong oxidizing agent, are preferably formic acid and its salt, oxalic acid and its salts ascorbic acid and its salt, aldehydes, pyrogallol, hydroquinone, gold (fine grains, grains, plate), salts containing low atomic value metal ions (Fe²⁺, Sn²+, Ti³⁺, or Cr²⁺) and the like.

The additives which are compounds reactable with triiodide ions may be used alone, or at least two types thereof may be used in combination. The addition amount of the additives is not particularly limited as long as the effects of the present invention are not seriously damaged; however, with respect to the amount of triiodide ions which is excessively present in a plating liquid, the amount is generally 0.1 times or more on a molar basis and is preferably 0.2 times or more. In addition, the amount is generally 2 times or less on a molar basis and is preferably 1.8 times or less.

The substances capable of adsorbing and removing triiodide ions are preferably active carbon and at least one type of ion exchange resins. The addition amount of these substances is appropriately determined in accordance with the ability of removing triiodide ions.

The temperature of a gold plating liquid when these additives are added is preferably high in order to increase the reaction rate, and is generally 20° C. or more, preferably 30° C. or more, and more preferably 40° C. or more. However, in order to prevent evaporation of a solvent and not to change the composition of a plating liquid, the temperature is preferably not so high and is generally 80° C. or less, preferably 70° C. or less, and more preferably 60° C. or less.

### EXAMPLE AND COMPARATIVE EXAMPLE

With reference to the following example and comparative example, the particular embodiment of the present invention will be described; however, the present invention is not limited to the following examples at all as long as it is within the scope and spirit of the present invention. Incidentally, in the following examples, gold having a purity of 99.99%, manufactured by Rare Metallic Co. Ltd., was used, and iodine, potassium iodide, ethylene glycol, and diethylene glycol, which were used in the examples, were special grade chemicals manufactured by Wako sure Industries, Ltd.

### Example 1

To a three neck flask equipped with a stirrer, 10 g of gold, 40 g of potassium iodide, 8 g of iodine, 392 g of water, and 550 g of diethylene glycol were charged, followed by mixing at 75° C. by stirring Gold was totally dissolved by stirring for 16 hours. By using a gold plating liquid thus obtained, when plating was performed on a gold sputtered film (cathode) at a current density of 4 mA/cm² for 90 minutes while gold was used for a counter electrode (anode), plating was performed at a voltage of approximately 0.1 V.

The element distribution of the plating film thus formed and the sputtered film used as an underlayer was analyzed by an Auger electron spectroscopy in the depth direction, and as a result, it was confirmed that the plating film is a film containing gold as a primary element.

In this example, the time required for forming the total film including the plating film and the underlayer was approximately 3 times that required for forming only the underlayer, and hence it was also confirmed that the gold plating film has a sufficient film thickness.

### Comparative Example 1

To a three neck flask equipped with a stirrer, raw materials were charged in the same manner as that described above except that ethylene glycol was used instead of diethylene glycol which was used in Example 1, followed by mixing at 70° C. by stirring. Gold was not totally dissolved even when stirring was performed for 80 hours.

From the results of the above Example 1 and Comparative Example 1, it was found that compared to ethylene glycol, diethylene glycol has a high ability to stably dissolve a gold complex and is suitable as a solvent of a gold plating liquid.

The present invention has been described in detail with reference to the particular embodiments; however, it is apparent to a person skilled in the art that various modification can be made without departing from the scope and spirit of the present invention.

In addition, this application claims the benefit of Japanese Application No 2004-319451 filed Nov. 2, 2004, which is hereby incorporated by reference herein.

1. A gold plating liquid comprising:
at least one of iodine and iodide ions;
gold ions; and
a polyalcohol having at least 4 carbon atoms.

2. The gold plating liquid according to claim 1, wherein the polyalcohol having at least 4 carbon atoms is at least one of diethylene glycol and triethylene glycol.

3. The gold plating liquid according to claim 1, further comprising water.

4. A gold plating method using the gold plating liquid according to claim 1.

5. The gold plating method according to claim 4, wherein the gold plating method is an electrolytic plating method.

6. The gold plating method according to claim 5, wherein gold or a gold alloy is used for an anode.

7. The gold plating method according to claim 5, wherein when an insoluble material is used for an anode, a compound, which is reactable with triiodide ions by-produced by a gold plating reaction performed at a cathode is added to the gold plating liquid, whereby a current efficiency of the gold plating liquid is not decreased.

8. The gold plating method according to claim 7, wherein the compound reactable with triiodide ions is at least one of an alkyl-substituted phenol and a reducing agent.

9. The gold plating method according to claim 8, wherein the alkyl-substituted phenol is at least one selected from the group consisting of 3-methoxyphenol, 3-ethoxyphenol, and 3,5-xylenol, and the reducing agent is at least one selected from the group consisting of formic acid, a salt thereof, oxalic acid, a salt thereof ascorbic acid, a salt thereof, and gold.

10. The gold plating method according to claim 5, wherein when an insoluble material is used for an anode, a material, which is able to adsorb and remove triiodide ions by-produced by a gold plating reaction performed at a cathode, is added to the gold plating liquid whereby a current efficiency of the gold plating liquid is not decreased.

11. The cold plating method according to claim 10, wherein the material which is able to adsorb and remove triiodide ions is active carbon.

12. The gold plating method according to claim 7, wherein when an additive is added to the gold plating liquid, the temperature of the gold plating liquid is in the range of 20 to 80° C.
